(19) United States
(12) Patent Application Publication
(10) Pub. No.: US 2019/0102746 A1
(43) Pub. Date: Apr. 4, 2019

(54) SYSTEMS AND METHOD FOR DYNAMIC SCHEDULING OF SERVICE APPOINTMENTS

(71) Applicant: ServiceNow, Inc., Santa Clara, CA (US)

(72) Inventors: Sanjay Gupta, Saratoga, CA (US); Devinder Narang, Palo Alto, CA (US); Abhishek Rakshe, Santa Clara, CA (US); Ryan Currier, Cupertino, CA (US); Puja Subramanyam, Milpitas, CA (US); Cameron Wheeler, Mountain House, CA (US); Jessica Quittner, San Jose, CA (US)

(21) Appl. No.: 15/722,976

(22) Filed: Oct. 2, 2017

(51) Int. Cl. G06Q 10/10; G06Q 30/00

(52) U.S. Cl. CPC G06Q 10/1095; G06F 17/30241; G06Q 30/016

(57) ABSTRACT

A system includes a non-transitory memory and one or more hardware processors configured to read instructions from the non-transitory memory. The one or more hardware processors are configured to perform operations including receiving a service appointment request, identifying the one or more skills associated with the service appointment request, referencing service agent profile data stored on a first database, wherein the service agent profile data includes one or more skills possessed by each of a plurality of service agents, referencing service agent schedule data stored on a second database, dynamically populating a calendar of available appointment times, including identifying one or more time slots, occurring during a period of time, during which at least one service agent of the plurality of service agents possesses the identified skills is available, receiving an input selecting a first time slot of the one or more time slots, and updating a schedule of a first service agent of the plurality of service agents to reflect that the first service agent has a service appointment scheduled during the first time slot.

### BACKGROUND

This section is intended to introduce the reader to various aspects of art that may be related to aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Individuals, enterprises, and other organizations may utilize software resources, via multiple devices connected to a network, to conduct activities or otherwise run an organization. Set up, expansion, maintenance, and normal use of such systems may give rise to issues that a user may not have the expertise to resolve on his or her own. In such cases, a customer service agent may be utilized to quickly and efficiently resolve the issue, in person or from a remote location. Manually coordinating the scheduling of service appointments based on service agent location, availability, and subject matter expertise (e.g., skills) may substantially increase the time elapsed between when the service appointment request is received and when the service request is closed, upon resolution of the issue.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The disclosed techniques generally relate to dynamic scheduling of service appointments based on service agent skill, schedule, and location. Service agent profiles may be maintained on one or more databases. Each profile may include one or more skills and/or areas of expertise possessed by the user. Service agent schedules and locations may also be maintained on one or more databases, which may be the same or different from the one or more databases storing the profile data. When a service appointment request is submitted, the request is parsed and/or processed to determine one or more skills associated with the proceeding service appointment. The profile data and scheduling data may then be referenced to display, in real time or near-real time, available appointment time slots during which a service agent with the identified skills is available at or near a specified location. The user may then select a convenient time for the service appointment. The schedule of the agent to which the service appointment is assigned will then be updated to reflect that the agent has a service appointment during the scheduled time.

### BRIEF DESCRIPTION OF THE DRAWINGS

The description herein makes reference to the accompanying drawings, wherein like reference numerals refer to like parts throughout the several views.

FIG. 1 is a block diagram of a distributed computing system utilizing a platform and a database (DB), in accordance with an embodiment;

FIG. 2 is a schematic of an embodiment of a multi-instance architecture that may be utilized by the distributed computing system of FIG. 1, in accordance with an embodiment;

FIG. 3 is a block diagram of a computing device utilized in the distributed computing system of FIG. 1, in accordance with an embodiment;

FIG. 4 is a schematic of an embodiment of a customer service architecture implemented by the distributed computing system of FIG. 1, in accordance with an embodiment;

FIG. 5 is an embodiment of a work order screen a user sees when scheduling a service appointment created by the user, in accordance with an embodiment;

FIG. 6 is an embodiment of a work order screen the user sees when scheduling a service appointment created by an administrator, in accordance with an embodiment;

FIG. 7 is a schematic illustrating service agent availability during a specified time slot, in accordance with an embodiment;

FIG. 8 is an embodiment of a dynamic scheduling window for scheduling the service appointment, in accordance with an embodiment;

FIG. 9 is an embodiment of the work order screen of FIG. 6 once the service appointment has been scheduled, in accordance with an embodiment;

FIG. 10 is an embodiment of a work order screen seen by a service manager or service agent, in accordance with an embodiment; and

FIG. 11 is a flow chart of a process for dynamic scheduling of a service appointment, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Information Technology (IT) is increasingly important in an electronics-driven world in which enterprises and other organizations utilize computers to conduct operations and help run their organizations. However, hardware and software resources used by organizations may take a significant time investment for users to set up, learn to operate, and troubleshoot. This results in reduced efficiency for software resource customers as users tend to the software resource instead of performing their usual tasks. Accordingly, software resource providers may provide users with a customer service architecture that may include self-help (e.g., posted how-to guides, set up guides, troubleshooting guides, etc.), peer-to-peer or crowdsourced assistance (e.g., forums or message boards), and a team of customer service agents that can assist customers onsite or from a remote location. Manually coordinating the scheduling of service appointments uses a significant amount of resources. By referencing service agent locations, schedules, and areas of expertise (e.g., skills) from one or more databases, available service appointments may be dynamically displayed to a user, enabling the user to select the most convenient appointment time when the service appointment request is submitted. Thus, by employing the disclosed techniques, a service agent's schedule may be populated in real time or near real time as users book service appointments, thus reducing the time from service appointment request submission to issue resolution and service ticket closure.

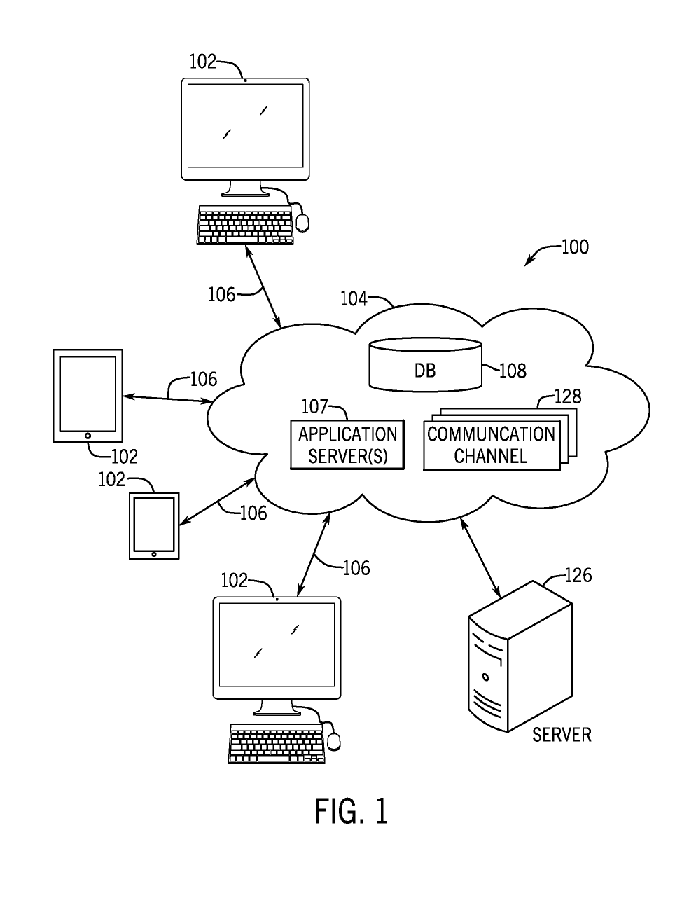

With the preceding in mind, FIG. 1 is a block diagram of a system 100 that utilizes distributed computing and that may be used in conjunction with the approaches discussed herein for providing customer service. As illustrated, one or more clients 102 communicate with a platform 104 (e.g., a cloud service) over a communication channel 106. Each client 102 may include any suitable computing system, such as a mobile phone, a tablet computer, a laptop computer, a notebook computer, a desktop computer, or any other suitable computing device or combination of computing devices. Each client 102 may include client application programs running on the computing devices.

The platform 104 may include any suitable number of computing devices (e.g., computers) in one or more locations that are connected together using one or more networks. For instance, the platform 104 may include various computers acting as servers in datacenters at one or more geographic locations where the computers are connected together using network and/or Internet connections. The communication channel 106 may include any suitable communication mechanism for electronic communication between each client 102 and the platform 104. The communication channel 106 may incorporate local area networks (LANs), wide area networks (WANs), virtual private networks (VPNs), cellular networks (e.g., long term evolution networks), and/or other network types for transferring data between the client 102 and the platform 104. For example, the communication channel 106 may include an Internet connection when the client 102 is not on a local network common with the platform 104. Additionally or alternatively, the communication channel 106 may include network connection sections when the client and the platform 104 are on different networks or entirely using network connections when the client 102 and the platform 104 share a common network. Although only four clients 102 are shown connected to the platform 104 in the depicted example, it should be noted that platform 104 may connect to any number of clients (e.g., tens, hundreds, thousands, or tens of thousands of clients).

Through the platform 104, the client 102 may connect to various devices with various functionality, such as gateways, routers, load balancers, databases, application servers running application programs on one or more nodes, or other devices that may be accessed via the platform 104. For example, the client 102 may connect to an application server 107 and/or a database (DB) 108 via the platform 104. The application server 107 may include any computing system, such as a desktop computer, laptop computer, server computer, and/or any other computing device capable of providing functionality from an application program to the client 102. The application server 107 may include one or more application nodes running application programs whose functionality is provided to the client via the platform 104.

The DB 108 includes a series of tables containing information about assets and services controlled by a client 102 and the configurations of these assets and services. The assets and services may include records of computers, other devices on a network (or group of networks), software contracts and/or licenses, enterprise services; hardware resources, such as server computing devices, client computing devices, processors, memory, storage devices, networking devices, or power supplies; software resources, such as instructions executable by the hardware resources including application software or firmware; virtual resources, such as virtual machines or virtual storage devices; and/or storage constructs such as data files, data directories, or storage models.

Additional to or in place of the DB 108, the platform 104 may include one or more other database servers. The database servers are configured to store, manage, or otherwise provide data for delivering services to the client 102 over the communication channel 106. The database server includes one or more databases (e.g., DB 108) that are accessible by the application server 107, the client 102, and/or other devices external to the databases. In some embodiments, more than a single database server may be utilized. Furthermore, in some embodiments, the platform 104 may have access to one or more databases external to the platform 104 entirely.

Access to the platform 104 is enabled by a server 126 via a communication channel 128. The server 126 may include an application program (e.g., Java application) that runs as a service (e.g., Windows service or UNIX daemon) that facilitates communication and movement of data between the platform 104 and external applications, data sources, and/or services. The server 126 may be implemented using a computing device (e.g., server or computer) on the network 112 that communicates with the platform 104.

The application servers 107 may store content accessible by one or more users via one of the clients. For example, the application server 107 may store one or more pages (e.g., Community pages, knowledge management pages, customer service management pages, and so forth, as discussed herein) with which one or more of the users may interact (e.g., view, post, etc.) with other users and/or customer service agents. As a result, users may use the pages to resolve issues that arise through installation, expansion, maintenance, and regular use of the network, either on their own, or with the help of a customer service agent.

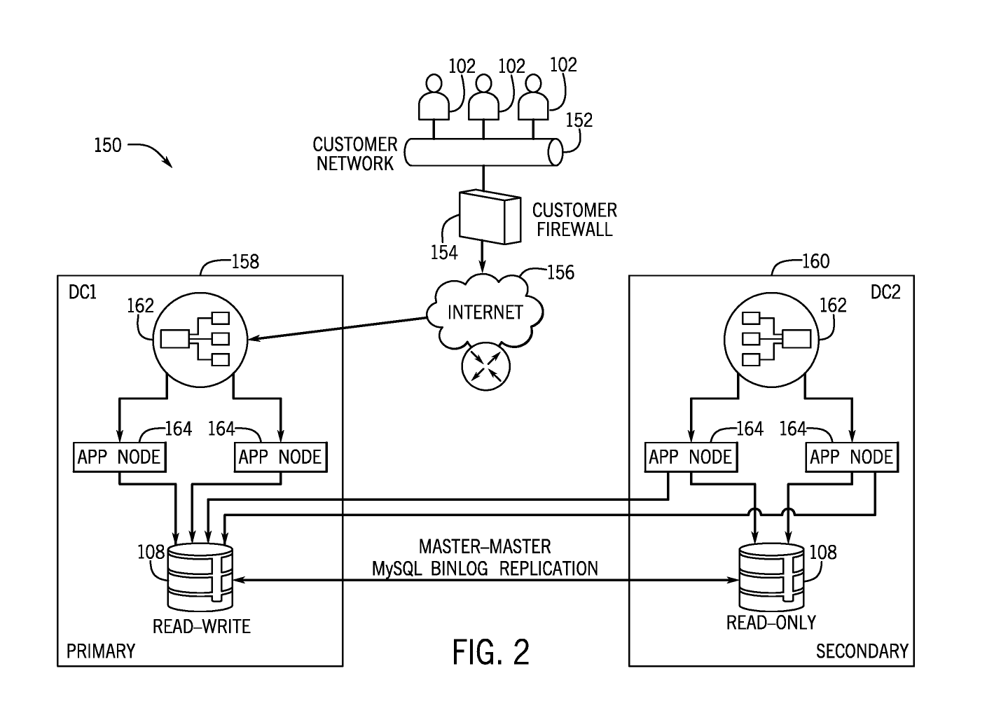

FIG. 2 is a schematic of an embodiment of a multi-instance architecture 150 that may be utilized by the distributed computing system 100 of FIG. 1. As shown, one or more clients 102 are connected to a customer network 152, which may or may not be protected by a firewall 154. The one or more clients 102 may access first and second virtual machines 158, 160 via the Internet 156. In the illustrated embodiment, the first virtual machine 158 is a primary virtual machine 158 and the second virtual machine 160 is a secondary virtual machine. The primary and secondary virtual machines 158, 160 are disposed in different data centers. Other embodiments may include more than two virtual machines (e.g., multiple secondary virtual machines). As shown, each of the virtual machines 158, 160 includes at least one load balancer 162, multiple application nodes 164, and a DB 108. In the illustrated embodiment, the database 108 of the primary virtual machine 158 is read-write and the database 108 of the secondary virtual machine 160 is read-only. The databases 108 are replicated via MySQL binlog replication for near real-time replication between the primary database 108 and the secondary database 108. As shown, the application nodes 164 of the primary virtual machine 158 may access the primary database 108, while the applications nodes 164 of the secondary virtual machine 160 may access both the primary database 108 and the secondary database.

Each customer may have its own dedicated virtual machines 158, 160 and database processes. Further, full and incremental backups may be scheduled as the customer wishes (e.g., daily, weekly, bi-weekly, monthly, etc.). The multi-instance architecture 150 results in full instance redundancy for all production instances with near real time replication and no comingling of data between customers. By providing customers with their own database(s) 108, customers are isolated from database maintenance and/or database failure of other customers. Further, maintenance and repair windows are shorter. In some embodiments, a client may pull data from multiple different databases 108 distributed over multiple virtual machines 158 and/or data centers. The pulled data may then be combined and used as inputs to perform a task, such as dynamic scheduling of service appointments.

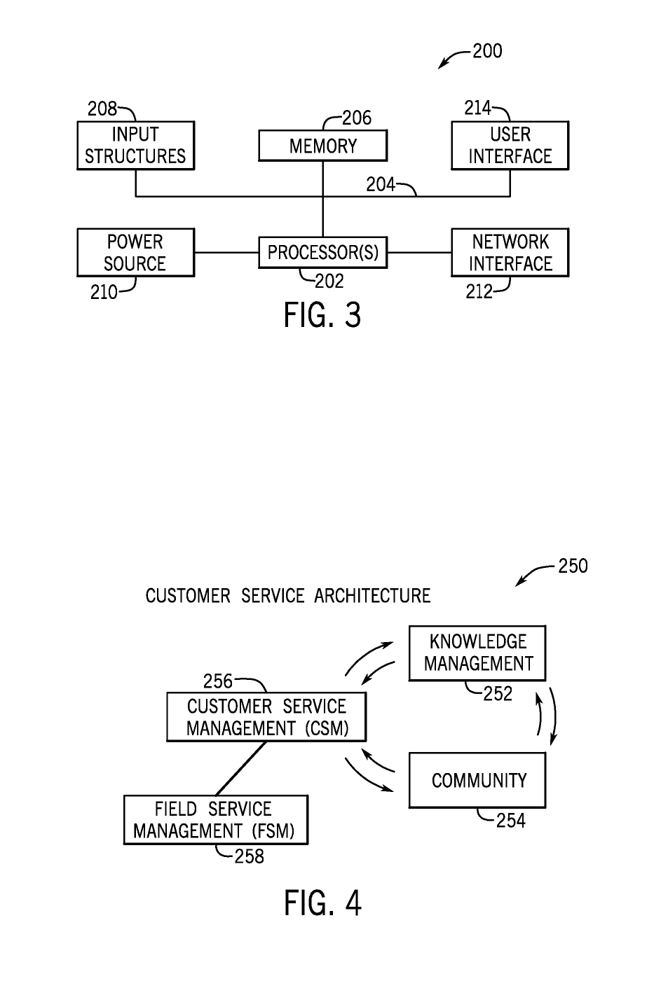

FIG. 3 generally illustrates a block diagram of an embodiment of an internal configuration of a computing device 200. With respect to FIGS. 1-3, the computing device 200 may be an embodiment of the client 102, the application server 107, a virtual machine 158, 160, a database server (e.g., DB 108), other servers in the platform 104 (e.g., server hosting the communication channel 128), and/or a device running the server 126. These devices may include a computing system that includes multiple computing devices and/or a single computing device, such as a mobile phone, a tablet computer, a laptop computer, a notebook computer, a desktop computer, a server computer, and/or other suitable computing devices.

As illustrated, the computing device 200 may include various hardware components. For example, the device includes one or more processors 202, one or more busses 204, memory 206, input structures 208, a power source 210, a network interface 212, a user interface 214, and/or other computer components useful in performing the functions described herein.

The one or more processors 202 may include a processor capable of performing instructions stored in the memory 206. For example, the one or more processors may include microprocessors, system on a chips (SoCs), or any other circuitry capable of performing functions by executing instructions, such as instructions stored in the memory 206. Additionally or alternatively, the one or more processors 202 may include application-specific integrated circuits (ASICs), field-programmable gate arrays (FPGAs), and/or other devices that may perform the functions discussed herein without calling instructions from the memory 206. Moreover, the functions of the one or more processors 202 may be distributed across multiple processors in a single physical device or in multiple processors in more than one physical device. The one or more processors 202 may also include specialized processors, such as a graphics processing unit (GPU).

The one or more busses 204 includes suitable electrical channels to provide data and/or power between the various components of the computing device. For example, the one or more busses 204 may include a power bus from the power source 210 to the various components of the computing device. Additionally, in some embodiments, the one or more busses 204 may include a dedicated bus among the one or more processors 202 and/or the memory 206.

The memory 206 may include any tangible, non-transitory, and computer-readable storage media. For example, the memory 206 may include volatile memory, non-volatile memory, or any combination thereof. For instance, the memory 206 may include read-only memory (ROM), randomly accessible memory (RAM), disk drives, solid state drives, external flash memory, or any combination thereof. Although shown as a single block in FIG. 2, the memory 206 can be implemented using multiple physical units in one or more physical locations. The one or more processor 202 accesses data in the memory 206 via the one or more busses 204.

The input structures 208 provide structures to input data and/or commands to the one or more processor 202. For example, the input structures 208 include a positional input device, such as a mouse, touchpad, touchscreen, and/or the like. The input structures 208 may also include a manual input, such as a keyboard and the like. These input structures 208 may be used to input data and/or commands to the one or more processors 202 via the one or more busses 204. The input structures 208 may also monitor operating conditions (e.g., temperatures) of various components of the computing device 200, such as the one or more processors 202.

The power source 210 can be any suitable source for power of the various components of the computing device 200. For example, the power source 210 may include line power and/or a battery source to provide power to the various components of the computing device 200 via the one or more busses 204.

The network interface 212 is also coupled to the processor 202 via the one or more busses 204. The network interface 212 includes one or more transceivers capable of communicating with other devices over one or more networks (e.g., the communication channel 106). The network interface may provide a wired and/or wireless network interface. Moreover, the computing device 200 may communicate with other devices via the network interface 212 using one or more network protocol.

A user interface 214 may include a display that is configured to display images transferred to it from the one or more processors 202. In addition to and/or alternative to the display, the user interface 214 may include other devices for interfacing with a user. For example, the user interface 214 may include lights (e.g., LEDs), speakers, haptic feedback, and the like.

As discussed herein, a user may use a computing device 200 to access various components of a customer service architecture in order to resolve issues, either on their own, with the assistance of other users, or with the assistance of a customer service agent.

FIG. 4 is a schematic of a generalized customer service architecture 250. In the illustrated example, the customer service architecture 250 includes Knowledge Management component 252, a Community component 254, a Customer Service Management (CSM) component 256, and Field Service Management (FSM) component 258. However, it should be understood that a customer service architecture 250 may vary from what is shown, and other example architectures may include additional components that are not shown, fewer components, of different combinations of components.

The Knowledge Management component 252 includes navigable pages with information designed to help users resolve issues on their own. For example, the Knowledge Management component 252 may include blog posts, essays, photo essays, how-to guides, troubleshooting guides, and the like, organized by topic. For example, a user may be having trouble connecting a specific model of router to a network after updating the router's firmware. The user may search the Knowledge Management component 252 or navigate a series of nested menus to find a page that helps the user resolve the issue (e.g., “troubleshooting guide following firmware update for router X”, or “resolving connectivity issues for model X”). For some common issues, the Knowledge Management component 252 may be the most efficient way to resolve some issues that arise. For example, for issues that arise frequently and are easy to resolve, rather than utilizing the bandwidth of a customer service agent to help customers resolve the issue over and over again across multiple customer networks, it may be more efficient to have a page on the Knowledge Management component 252 that walks users through resolving the problem on their own. Customer service agents may be available to help users who are unable to resolve the issue on their own, or are uncomfortable trying to resolve the issue on their own. Further, because the Knowledge Management component 252 is immediately accessible to users 24-hours a day, a user may be able to resolve the issue quickly without having to wait on a customer service agent or another user to assist them.

In some instances, a user may not be able to resolve the issue on their own using the Knowledge Management component 252. For example, the Knowledge Management component 252 may not yet have a page directed to the issue, or the existing page may not yet include the specific action to resolve the specific instance of the issue (e.g., which may be unique to the user based on the specific circumstances, combination of hardware/software, etc.). In such circumstances, the Community component 254 may be helpful in resolving the issue.

The Community component 254 includes a collection of pages that users may post, read, or otherwise interact with. For example, the Community component 254 may include forums and/or message boards, questions and answers, blogs, videos, photos, links, text, etc. through which users may interact with one another. Though the Community component 254 may cover a wide range of topics and subject matter, one aspect of the Community component 254 is crowdsourcing of issue resolution. For example, a user facing an issue, such as the router conductivity after firmware update example discussed above, may post an object on the Community component 254 soliciting assistance from other users in resolving the issue. Specifically, the user may be unable to resolve the issue using the Knowledge Management component 252, either because there was not yet a page directed to the issue, the user was unable to find the page, or there was a page directed to the issue, but the specific circumstances of the user made the suggested remedial actions inapplicable to the user's specific issue. The user, not wanting to trouble a customer service agent, may then move to the Community component to find a resolution. As with the Knowledge Management component 252, the user may be able to search or navigate nested menus to find posts related to his or her specific issue. If the user is unable to find a related post, the user may create their own post (e.g., ask a question, write a blog, post a photo, post a video, or other text strings or media) soliciting assistance from other users. The post may be visible to other users when they log on to the Community component 254. The other users may then reply to the post, comment on the post, post a link (e.g., to a Knowledge component 252 page), or send the original posting user a message suggesting how to resolve the issue. The helping users may then acquire points toward their profiles as a way to encourage participation. In some cases, posts and/or exchanges on the Community component 254 successfully resolving an issue may be turned into pages on the Knowledge Management component 252 or used to revise pages on the Knowledge Management component 252.

Another available resource for a user to resolve issues is the CSM component 256. If the user is unable to resolve the issue using the Knowledge Management component 252 or the Community component 254, or the user would rather have the assistance of a customer service agent, the user may utilize the CSM component 256 to request the help of a customer service agent to resolve the issue, either in person or remotely. For example, the user may utilize the CSM component 256 to generate a service appointment request, or “ticket”. The user may provide various information about the issue and request an appointment. As is described in more detail below, once the user has provided some information, a schedule of available appointments is displayed (e.g., based on service agent location, scheduling availability, and skillset) for the user's selection. The ticket is then assigned to a customer service agent. For a remote appointment, the assigned customer service agent interacts with the user remotely (e.g., via phone, voice over internet protocol (VOIP), voice or video conferencing, remote desktop, a chat window, etc.) to resolve the issue remotely. In some cases, the customer service agent may not be able to resolve the issue remotely, or it may be preferable to have a customer service agent address the issue in person. The customer service agent may then refer the user to the FSM component 258, by which the service ticket may be assigned to a field service agent who can come to diagnose and resolve the issue on-site. When the issue has been resolved, the ticket is closed.

As discussed herein, profiles may be built for customer service agents based on the activities (e.g., resolving service requests, completing training courses, obtaining certifications, etc.) he or she performs. As activities are performed (which may be indicated by the closure of a service ticket), skills associated with each activity are identified and the agent is awarded credit toward those skills. For example, a service request may be analyzed to determine the skills used to resolve the issue, or otherwise related to the issue (e.g., network connectivity, security, programming, network architecture, etc.) and the difficulty of the issue. A service agent's profile and associated skills may be stored in one or more databases. Over time, the agent's profile (e.g., skills possessed across a range of skills) comes to represent the skillset or skill profile of the agent. When service appointment requests are received, they may be processed or otherwise evaluated to identify the likely skills used to resolve the request. Accordingly, the profiles of available agents may be compared to the skills associated with the pending service request to identify the agent or agents capable of handling the service request. One or more databases storing customer service agent skills, locations, and schedules may be referenced to determine appointment times during which a capable service agent is available at the location. The system may display the available appointment times, and receive a user's selection of a convenient appointment time. The service ticket is then assigned to a customer service agent, whose schedule is updated to reflect the service appointment.

All of the users with access to the various components 252, 254, 256, 258 of the customer service architecture 250 (e.g., users, customer service agents, field service agents, network administrators, service managers, etc.) may have an associated profile. A customer service agent's profile data, including skills or skills ratings may be stored in one or more databases (e.g., the databases 108 shown in FIGS. 1 and 2), along with the customer service agent's schedule (including geographical location). When a customer is filling out and submitting a customer service appointment request, the stored profile and schedule data for one or more customer service agents may be referenced to determine available appointment times when a capable customer service agent is available and in or near a specified location.

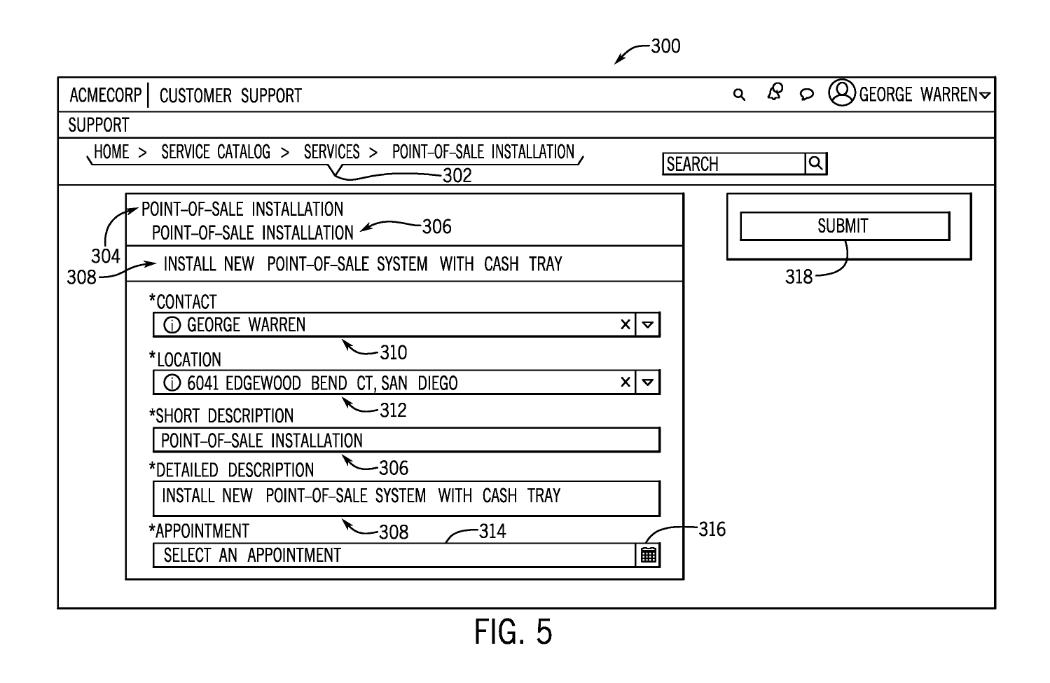

FIG. 5 is an embodiment of a work order screen 300 a user sees when scheduling a service appointment created by the user. As illustrated from the path 302, the user, in this example, George Warren, navigated from a home screen through a service catalog, and a list of available services to select a point of sale installation. Based on the customer's selection, a work order name 304 (e.g., “point of sale installation”), short description 306, and detailed description 308 are displayed. As shown, the short description 306, and detailed description 308 may be edited in the fields below. The work order screen 300 also includes a contact name 310 (e.g., George Warren) for the work order, and a location for the work order 312 (e.g., 6041 Edgewood Bend Ct., San Diego, Calif.). The contact may or may not be the user that is scheduling the appointment.

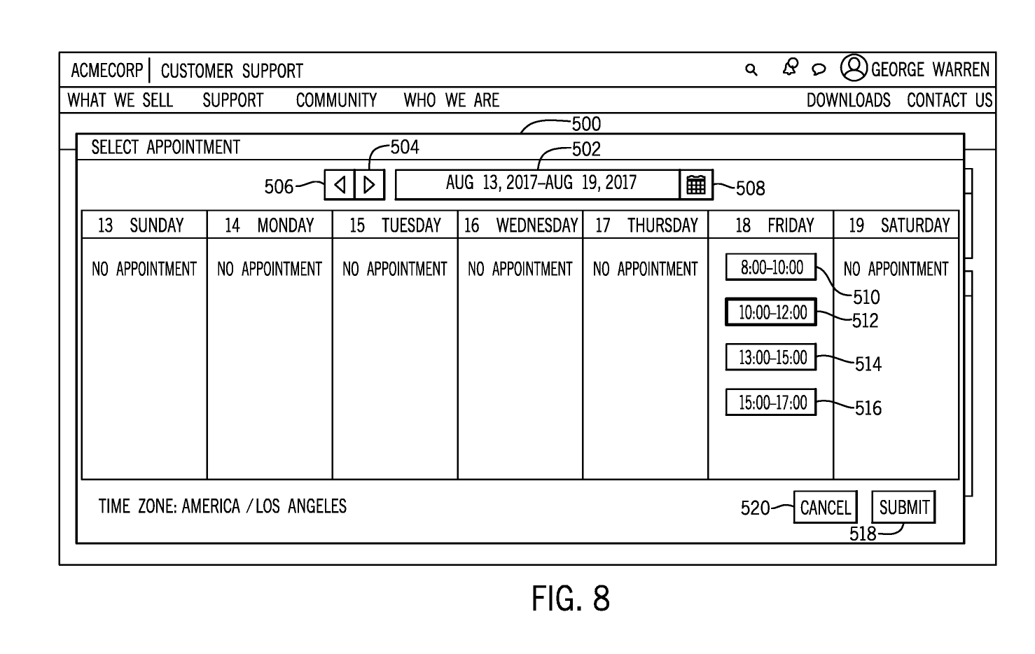

The screen 300 also includes an appointment window 314 and a calendar button 316. If an appointment has been scheduled, the appointment window 314 displays the date and time of the scheduled appointment. If an appointment has not yet been scheduled, as is the case in FIG. 5, the appointment window 314 displays “Schedule an appointment” encouraging the user to schedule an appointment for the work order. The user may select the calendar button 316 to cause a dynamic scheduling window to appear and display available appointment times. As previously described, an available appointment time slot is a time slot during which a customer service agent with the skills associated with the work order is available and at or near the specified location 312. The dynamic scheduling window is shown and described with regard to FIG. 8. Once an appointment time slot has been selected, the user may select the submit button 318 to schedule the appointment. In some embodiments, the work order may be created by someone other than the user (e.g., customer service agents, field service agents, network administrators, service managers, etc.). In further embodiments, the work order may be created automatically. The user then may log on and be prompted to schedule a service appointment for a work order that was created for them.

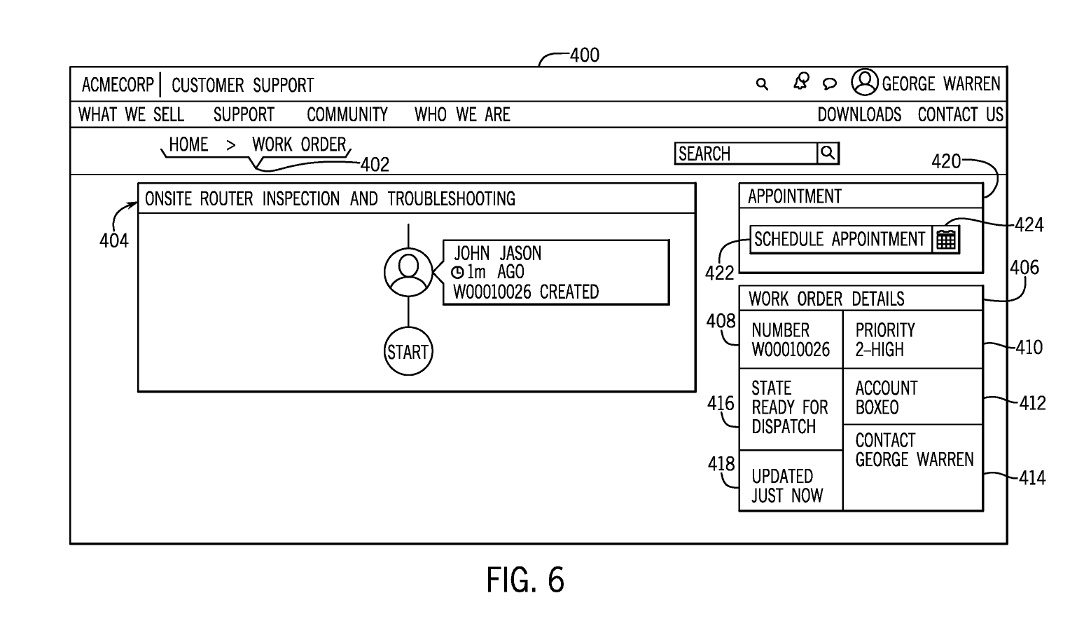

FIG. 6 is an embodiment of a work order screen 400 a user sees when scheduling a service appointment created by an administrator (e.g., John Jason). As illustrated from the path 402, the user, in this example, George Warren, has selected “work order” from a home screen. In some embodiments, the user may receive a notification alerting them that a work order has been created for them. The administrator has provided sufficient information that a work order summary 404 (e.g., “Onsite router inspection and troubleshooting”) has been created and a work order details window 406 has been populated. For example, the work order has been assigned a number 408 and a priority level 410. The priority level 410 may be automatically set based on the customer, a status of the requesting user, or the priority level 410 may be set by a service agent or service manager. The work order details window 406 also displays the account (i.e., customer) name 412, and the contact 414 (e.g., the requesting user), a work order status 416, and a time of last update 418. In some embodiments, the information used to fill in the work order summary and the work order details window 406 may be provided by the requesting user (e.g., George Warren), a network administrator for the customer, a technician, an account manager, a customer service agent, a customer service manager, or some other party.

The screen 400 also includes an appointment window 420, which includes an appointment time 422 and a calendar button 424. If an appointment has been scheduled, the appointment time 422 displays the date and time window of the scheduled appointment. If an appointment has not yet been scheduled, as is the case in FIG. 6, the appointment time 422 displays “Schedule appointment” encouraging the user to schedule an appointment for the work order. The user may select the calendar button 424 to cause a dynamic scheduling window to appear and display available appointment times. As previously described, an available appointment time slot is a time slot during which a customer service agent with the skills associated with the work order is available and at or near a specified location.

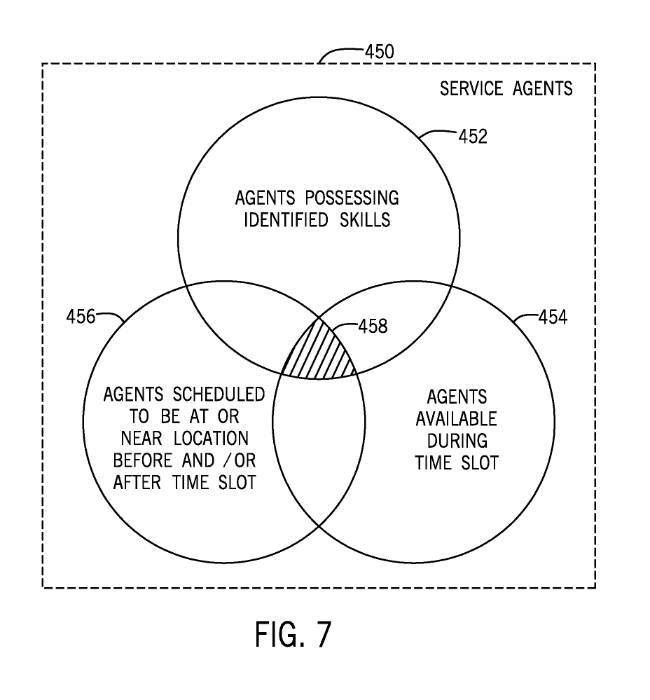

FIG. 7 is a schematic illustrating service agent availability during a specified time slot. Box 450 represents all of the agents on a team of agents. Circle 452 represents the agents within the team that possess the skills associated with work order. For example, one or more skills may be identified as being associated with the work order. Circle 454 represents the service agents whose schedules show them as being available during the time slot in question. Service agents may be unavailable because they have another appointment during the time slot in question, because they are not working during the time slot in question (e.g., the agent does not work that day, or that hour of the day, or is out on paid time off, etc.), or because the service agent is scheduled for some other task (e.g., skills training, meeting, etc.) and not available for service appointments during the time slot in question. Circle 456 represents agents that are scheduled to be at or near a specified location before or after the time slot in question. In the instant embodiment, “location” may be as specific as a physical address (e.g., 123 Main St., Suite 100), as broad as a region (e.g., Mid-Atlantic), or anywhere in between (e.g., neighborhood, zip code, town/city, metropolitan area, county, a custom defined zone, defined state region, state, etc.). In some embodiments, mileage and/or anticipated driving distance may be considered. For example, if a service agent from San Francisco, Calif. is scheduled to travel to San Jose, Calif. for an afternoon service appointment, the service agent may be shown as available for service appointments in locations that are nearby or along his or her expected travel route (e.g., Santa Clara, Sunnyvale, Mountain View, Palo Alto, Redwood City, etc.) before and after the service appointment. Further, the disclosed techniques may also be used for remote service appointments conducted via phone, remote desktop, videoconference, or some other technology. In such an embodiment, the location may not be the location of the customer requesting the work order, but rather a call center or other facility at which the service agent may conduct the remote service appointment. The shaded area 458 represents that agents possessing the associated skills are available during the time slot in question near the specified location. If this region 458 includes at least one agent, then the time slot will appear as available when the dynamic scheduling window appears. It should be understand that identifying the agents possessing the associated skills are available during the time slot in question near the specified location may be accomplished via many possible combinations of logic operations.

FIG. 8 is an embodiment of the dynamic scheduling window 500. As previously described, the dynamic scheduling window 500 appears when the user selects the calendar button 424 shown in FIG. 6. As shown, the dynamic scheduling window 500 displays available appointments for the week shown in the date range window 502. The user may adjust the dates shown by selecting the forward and backward arrows 504, 506 to move forward or backward one week, respectively. Alternatively, the user may select the calendar button 508 to select a week or day from a month or multi-month view. Though the current embodiment of the dynamic scheduling window 500 uses a week view, other embodiments may use a daily, monthly, or multi-monthly view, or some combination thereof (e.g., the user selects a day or week from a month view to see appointments available on that day or week). In the instant embodiment, the dynamic scheduling window 500 displays the appointments available for each day of the selected week. As shown, Friday, Aug. 18, 2017 is the only day during the selected week in which there are time slots during which service agents with the identified skills are at or near the specified location and available. The appointment for 10:00 am to 12:00 pm has been selected, as indicated by the box 512 for the time slot being shaded. The user may select any of the available time slots by selecting the corresponding boxes 510, 512, 514, 516. Once a convenient time slot has been selected, the user may select the submit button, at which point the appointment will be assigned to a customer service agent and added to his or her schedule. Alternatively, if the user wishes not to schedule a service appointment at this time, the user may select the cancel button 520, causing the dynamic scheduling window 500 to close without scheduling a service appointment. For some work orders (e.g., television installation), appointments may be considered mandatory, whereas for other work orders (e.g., point of sale installation), appointments may be considered optional.

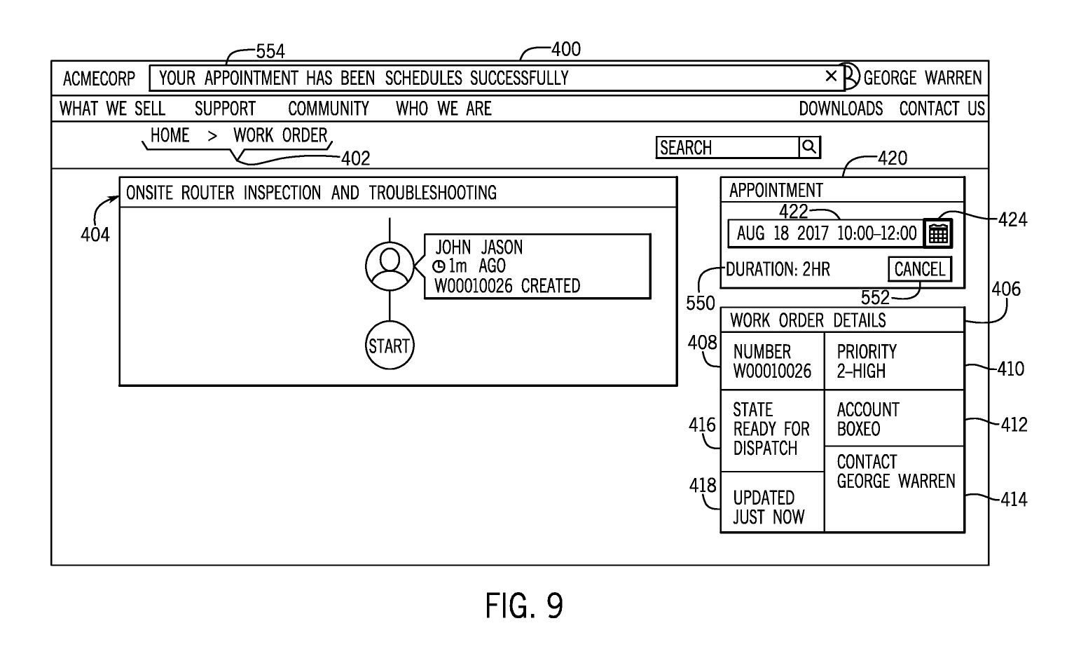

FIG. 9 is an embodiment of the work order screen 400 of FIG. 6 once the service appointment has been scheduled. As shown, the appointment time 422 within the appointment window 420 displays the date and time of the scheduled service appointment. Because a service appointment is scheduled, a service appointment duration 550 is shown (e.g., 2 hours) and a cancel button 552 is displayed, allowing the user to cancel the service appointment. Further, a notification banner 554 across the top of the work order window 400 appears temporarily, indicating that the service appointment has been successfully scheduled.

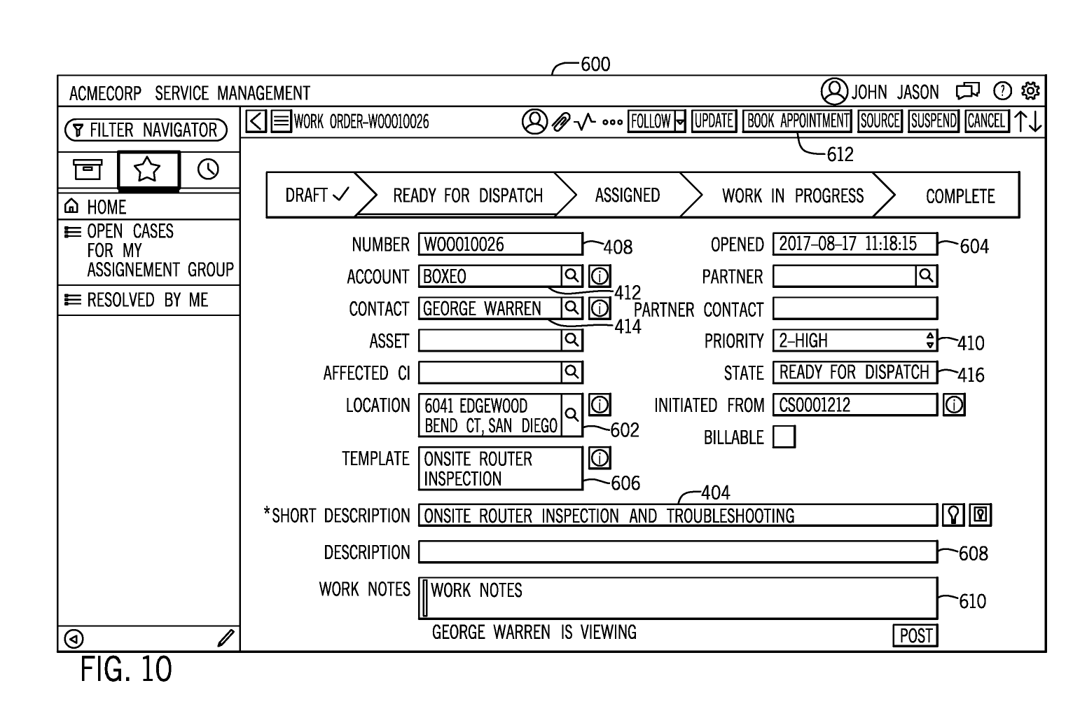

FIG. 10 is an embodiment of a work order screen 600 seen by a service manager or service agent. A blank version of the work order screen 600 may open when a service agent or service agent manager opens a new work order, or a populated version of the work order screen 600 may open upon selection of a work order that has already been created. In some embodiments, the work order screen 600 may be used by a service agent or service agent manager to provide information about a work order. For example, a customer may call a customer service agent seeking help. While on the phone with the customer, the customer service agent may open a new work order. The work order screen 600 may open and the service agent may fill in information. The customer may then be prompted to log in and schedule a service appointment, as discussed with regard to FIGS. 6-9. As shown, the work order screen 600 displays the information shown in the work order details window of FIGS. 6 and 9, as well as some additional information. For example, the work order screen 600 displays the location of the service appointment 602 and a date on which the work order was opened 604. Further, the screen 600 includes a template 606 associated with the work order. Most work orders include a limited number of set activities. In the instant embodiment, the work order has been identified as including an onsite router inspection. Accordingly, “onsite router inspection” is displayed in the template field. The template may convey information, such as appointment length, associated skills, etc. Accordingly, each template field may have one or more rules associated with it that affect how available appointment times are displayed when trying to schedule an appointment of a certain template type. The work order summary from FIGS. 5, 6 and 9 is carried over into the short description field 404. Additionally, the work order screen 600 includes a detailed description window 608 and a work notes window 610, which may be filled in by the customer service agent or the customer service manager. The book appointment button 612 indicates that an appointment has not yet been booked for this work order. Once an appointment has been booked, the book appointment button 612 will not be displayed when the service agent or the service manager logs in. As such, the work order screen 600 may be visible by the service agent or the service manager at any point from the creation of the work order and even following closure of the work order.

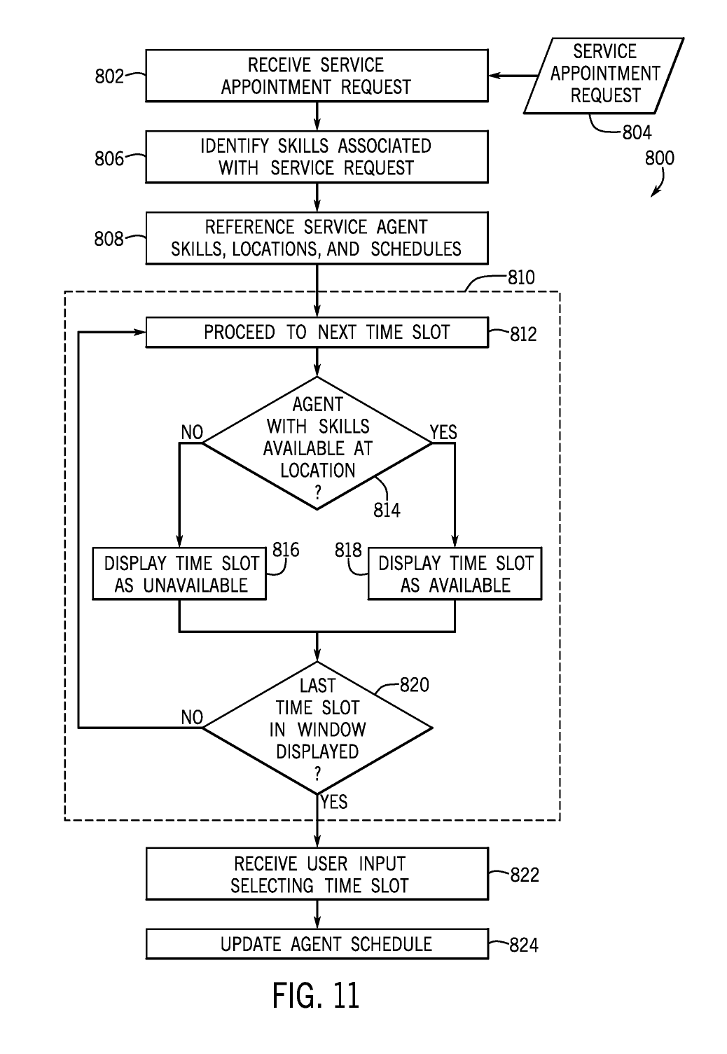

FIG. 11 is a flow chart of a process 800 for dynamic scheduling of service appointments. At block 802, the process 800 receives a service appointment request 804. The service request may be generated by a user, a network administrator for the customer, a technician, an account manager, a customer service agent, a customer service manager, or some other party. In embodiments in which the work order or service appointment request is generated by a third party and a service appointment has not yet been scheduled, a request or reminder to schedule a service appointment may be sent to the user. In block 806, the process 800 identifies one or more skills associated with the service appointment request 804. In some embodiments, the service appointment request 804 may include or be accompanied by information indicating the field associated with the service appointment request 804 (e.g., network architecture, network security, programming, component compatibility, etc.). In other embodiments, the process 800 may utilize text recognition and/or machine learning to identify skills associated with the service appointment request 804.

At block 808, the process 800 references service agent skills, locations, and schedules. This data may be pulled from a single database, or multiple disparate databases. The skills may be based on various activities (e.g., resolving service requests, completing training courses, obtaining certifications, etc.) performed by the agent and stored in their profile. The location may be as specific as an address (e.g., 123 Main St.), or as broad as a region (mid-Atlantic). Typically, the location may be based on an office or other location at which the service agent typically works, or based on the location of other appointments on the same day, either before or after, the time slot in question.

The process 800 then begins a subroutine 810 of populating the dynamic scheduling window. At block 812, the process 800 proceeds to the next time slot in the time window (e.g., week) specified by the user. At decision 814, the process 800 determines whether an agent with the identified skills is available at or near the specified location during the time slot in question. If an agent is not available, the process 800 proceeds to block 816 and displays the timeslot in question as unavailable. If an agent is available, the process 800 proceeds to block 818 and displays the timeslot as available. The process 800 proceeds to decision 820 and determines whether the last time slot in the specified window of time has been displayed. If the last time slot has not been displayed, the process 800 returns to block 812 and considers the next time slot. If the last time slot has been considered, the process 800 proceeds to block 822 and receives a user input selecting a time slot. At block 824, the process 800 updates the agent's schedule to indicate that the assigned agent is booked during the selected time slot.

The disclosed techniques generally relate to dynamic scheduling of service appointments based on service agent skill, schedule, and location. Service agent profiles may be maintained on one or more databases. Each profile may include skills, skill ratings, and/or areas of expertise. Service agent schedules and locations may also be maintained on one or more databases, which may be the same or different from the one or more databases storing the profile data. When a service appointment request is submitted, the request is parsed and/or processed to determine one or more skills associated with the proceeding service appointment. The profile data and scheduling data may then be referenced to display, in real time or near-real time, available appointment time slots during which a service agent with the identified skills is available at or near a specified location. The user may then select a convenient time for the service appointment. The schedule of the agent to which the service appointment is assigned will then be updated to reflect that the agent has a service appointment during the scheduled time.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system, comprising:
a non-transitory memory; and
one or more hardware processors configured to read instructions from the non-transitory memory to perform operations comprising:
receiving a service appointment request;
identifying the one or more skills associated with the service appointment request;
referencing service agent profile data stored on a first database, wherein the service agent profile data comprises one or more skills possessed by each of a plurality of service agents;
referencing service agent schedule data stored on a second database;
dynamically populating a calendar of available appointment times, comprising identifying one or more time slots, occurring during a period of time, during which at least one service agent of the plurality of service agents possesses the identified skills is available;
receiving an input selecting a first time slot of the one or more time slots; and
updating a schedule of a first service agent of the plurality of service agents to reflect that the first service agent has a service appointment scheduled during the first time slot.

2. The system of claim 1, wherein the service agent schedule data comprises a location of each of the plurality of service agents during scheduled appointments.

3. The system of claim 2, wherein a service agent of the plurality of service agents is considered available if the service agent does not have an appointment scheduled during the time slot and is scheduled to be within a threshold distance of a geographical location identified in the service appointment request.

4. The system of claim 1, wherein the service appointment is conducted from a remote location.

5. The system of claim 1, wherein the first database is stored at a first geographical location, and the second database is stored at a second geographical location, different from the first geographical location.

6. The system of claim 1, wherein the period of time is adjustable.

7. The system of claim 1, wherein the one or more skills are identified based on data provided in or with the service request.

8. The system of claim 1, wherein the operations comprise sending a reminder to schedule the service appointment.

9. A system, comprising:
a non-transitory memory; and
one or more hardware processors configured to read instructions from the non-transitory memory to perform operations comprising:
receiving a service appointment request;
identifying the one or more skills associated with the service appointment request;
referencing stored service agent profile data, wherein the service agent profile data comprises one or more skills possessed by each of a plurality of service agents;
referencing stored service agent schedule data;
referencing stored service agent location data;
dynamically populating a calendar of available appointment times, comprising identifying one or more time slots, occurring during a period of time, during which at least one service agent of the plurality of service agents possesses the identified skills is available at or near a specified location;
receiving an input selecting a first time slot of the one or more time slots; and
updating a schedule of a first service agent of the plurality of service agents to reflect that the first service agent has an appointment scheduled during the first time slot.

10. The system of claim 9, wherein a service agent of the plurality of service agents is considered available if the service agent does not have an appointment scheduled during the time slot and is scheduled to be within a threshold distance of a geographical location identified in the service appointment request.

11. The system of claim 9, wherein the specified location is defined in the service appointment request.

12. The system of claim 9, wherein the service appointment is conducted remotely and the specified location is a remote service center.

13. The system of claim 9, wherein the one or more skills are identified based on data provided in or with the service request.

14. The system of claim 9, wherein the operations comprise sending a reminder to schedule the service appointment.

15. The system of claim 9, wherein the period of time is adjustable via a dynamic scheduling window.

16. The system of claim 15, wherein the period of time is a week selected via the dynamic scheduling window

17. A method, comprising:
receiving a service appointment request;
identifying the one or more skills associated with the service appointment request;
referencing service agent profile data stored on a first database, wherein the service agent profile data comprises one or more skills possessed by each of a plurality of service agents;
referencing service agent schedule data stored on a second database;
dynamically populating a calendar of available appointment times, comprising identifying one or more time slots, occurring during a period of time, during which at least one service agent of the plurality of service agents possesses the identified skills is available;
receiving an input selecting a first time slot of the one or more time slots; and
updating a schedule of a first service agent of the plurality of service agents to reflect that the first service agent has a service appointment scheduled during the first time slot.

18. The method of claim 17, wherein the service agent schedule data comprises a location of each of the plurality of service agents during scheduled appointments.

19. The method of claim 18, wherein a service agent of the plurality of service agents is considered available if the service agent does not have an appointment scheduled during the time slot and is scheduled to be within a threshold distance of a geographical location identified in the service appointment request.

20. The method of claim 17, comprising sending a reminder to schedule the service appointment.
